(19) United States
(12) Patent Application Publication
(10) Pub. No.: US 2025/0368029 A1
(43) Pub. Date: Dec. 4, 2025

(54) HYBRID ELECTRIC VEHICLE

(71) Applicant: TOYOTA JIDOSHA KABUSHIKI KAISHA, Toyota-shi (JP)

(72) Inventors: Hiroyuki SHIBATA, Odawara-shi (JP); Tetsuro KOBAYASHI, Susono-shi (JP)

(73) Assignee: TOYOTA JIDOSHA KABUSHIKI KAISHA, Toyota-shi (JP)

(21) Appl. No.: 19/039,061

(22) Filed: Jan. 28, 2025

(30) Foreign Application Priority Data
May 28, 2024 (JP) 2024-086678

(51) Int. Cl. B60K 6/445; B60K 6/365; B60K 6/405

(52) U.S. Cl. CPC B60K 6/445; B60K 6/365; B60K 6/405; B60Y 2200/92; B60Y 2400/80

(57) ABSTRACT

A counter driven gear into which motive power is input from a second electric motor, a counter drive gear that has a smaller diameter than the counter driven gear and drives a differential gear device, and a counter shaft constitute a speed reduction mechanism. This eliminates the need for a ring gear on an outer side of a stepped pinion, and thus prevents an increase in an outside diameter of a first case cover on an engine side that protrudes from a case main body of a transaxle case so as to house the speed reduction mechanism. At least either part of the differential gear device or part of the counter shaft is disposed so as to protrude toward the engine side beyond an interface between the engine and the transaxle case, which can shorten a dimension of the transaxle case in the direction of a second axis.

### CROSS-REFERENCE TO RELATED APPLICATION

This application claims priority to Japanese Patent Application No. 2024-086678 filed on May 28, 2024, incorporated herein by reference in its entirety.

### BACKGROUND

### 1. Technical Field

The present disclosure relates to a hybrid electric vehicle including an engine, a first electric motor that is driven to rotate by the engine, a second electric motor, a speed reduction mechanism that reduces the speed of motive power of the second electric motor, and a differential to which the motive power is transmitted from the speed reduction mechanism.

### 2. Description of Related Art

A hybrid electric vehicle is known that includes an engine, a power split device, a first electric motor, a second electric motor, a speed reduction mechanism that reduces the speed of motive power of the second electric motor, and a differential mechanism to which the motive power is transmitted from the speed reduction mechanism. An example is the one described in Japanese Unexamined Patent Application Publication No. 2022-79981 (JP 2022-79981 A). In the hybrid electric vehicle described in JP 2022-79981 A, (a) an engine, a power split device, and a first electric motor are disposed along a first axis; (b) a second electric motor, a speed reduction mechanism, and a differential mechanism are disposed along a second axis that is parallel to the first axis; and (c) in the direction of the second axis, the second electric motor, the speed reduction mechanism, and the differential mechanism are disposed in this order from the first electric motor side toward the engine side. The hybrid electric vehicle described in JP 2022-79981 A includes a stepped-pinion-type planetary gear device as the speed reduction mechanism. The “stepped-pinion-type planetary gear device” is a planetary gear device which has a large-diameter pinion and a small-diameter pinion that rotate while unable to rotate relative to each other, and in which motive power is input into the large-diameter pinion from a sun gear that meshes with it while the small-diameter pinion meshes with a ring gear that is fixed on a non-rotary member, and the motive power is output from a carrier. The stepped-pinion-type planetary gear device is a speed reduction mechanism of which a speed reduction ratio is easy to increase and the efficiency of motive power transmission is less likely to decrease.

### SUMMARY

While an increase in the length of the stepped-pinion-type planetary gear device in the direction of its axis tends to be avoided, the outside diameter thereof relative to the axis tends to be large. Therefore, in the case where an engine protruding in a radial direction centered on a first axis and a stepped-pinion-type planetary gear device protruding in a radial direction centered on a second axis are disposed at positions overlapping in the direction of the first axis (the same direction as the direction of the second axis), an axis-to-axis distance between the first axis and the second axis may need to be increased to dispose the engine and the stepped-pinion-type planetary gear device so as not to overlap. An increase in the axis-to-axis distance between the first axis and the second axis leads to an increase in the overall size of the engine that is disposed so as to be rotatable around the first axis and a transaxle case that houses the first electric motor, the second electric motor, the speed reduction mechanism that reduces the speed of motive power of the second electric motor, and the differential mechanism to which the motive power is transmitted from the speed reduction mechanism. As a result, for example, the aerodynamic characteristics of the vehicle degrade or flexibility in vehicle design decreases. Such a situation arises not only in a parallel-type HEV but also in a split-type or series-type HEV.

The present disclosure has been developed in view of the above-described situation, and an object thereof is to provide a hybrid electric vehicle in which an increase in the overall size of the engine and the transaxle case can be avoided.

The gist of a first disclosure is: a hybrid electric vehicle in which, (a) inside a transaxle case combined with an engine, a planetary gear device, a first electric motor, and a crankshaft of the engine are disposed so as to be rotatable around a first axis; a second electric motor and a differential gear device are disposed so as to be rotatable around a second axis that is parallel to the first axis; and the second electric motor, a speed reduction mechanism, and the differential gear device are disposed in this order from a first electric motor side toward an engine side, wherein (b) the speed reduction mechanism includes a counter shaft that is provided so as to be rotatable around a third axis that is parallel to the first axis and the second axis, a counter driven gear which is provided on the counter shaft and into which motive power is input from the second electric motor, and a counter drive gear that has a smaller diameter than the counter driven gear and is provided on the counter shaft to drive the differential gear device; and (c) at least either part of the differential gear device or part of the counter shaft is disposed so as to protrude toward the engine side beyond an interface between the engine and the transaxle case.

According to the first disclosure, the speed reduction mechanism includes the counter shaft on which each of the counter driven gear into which motive power is input from the second electric motor and the counter drive gear that has a smaller diameter than the counter driven gear and drives the differential gear device is provided. This eliminates the need for a ring gear on the outer side of a stepped pinion, and thus prevents an increase in the outside diameter of a case cover on the engine side that protrudes from the transaxle case so as to house the differential mechanism. Since at least either part of the differential gear device or part of the counter shaft is disposed so as to protrude toward the engine side beyond an interface between the engine and the transaxle case, the dimension of the transaxle case in the direction of the second axis can be shortened.

The gist of a second disclosure is that, in the first disclosure, between the engine and the first electric motor, a planetary gear device is disposed, the planetary gear device having a sun gear that is connected to a rotor shaft of the first electric motor, a carrier that is connected to the crankshaft of the engine, and a ring gear with which a planetary gear supported by the carrier meshes; and that outer circumferential teeth of the ring gear mesh with the counter driven gear. Thus, the planetary gear device functions as a power split device, and the vehicle can be driven using a torque directly transmitted from the engine. In a split-type HEV, therefore, the axial length of the transaxle case in the direction of the second axis can be shortened.

The gist of a third disclosure is that, in the first disclosure, between the engine and the first electric motor, a planetary gear device is disposed, the planetary gear device having a sun gear that is connected to the first electric motor, a carrier that is connected to the engine, a planetary gear that is rotatably supported by the carrier, and a ring gear with which the planetary gear supported by the carrier meshes; and that the ring gear is fixed on the transaxle case. Thus, in a series-type HEV in which the engine drives the first electric motor to rotate through the planetary gear device functioning as a speed-increasing transmission and drives the second electric motor using electricity generated by the first electric motor, the axial length of the transaxle case in the direction of the second axis can be shortened. Another advantage is that an electric motor having a small diameter and a high rotation speed can be set as the first electric motor.

The gist of a fourth disclosure is that, in the first disclosure, the engine and the second electric motor are directly coupled to each other. Thus, in a series-type HEV in which the engine drives the first electric motor directly coupled thereto to rotate and drives the second electric motor using electricity generated by the first electric motor, the axial length of the transaxle case in the direction of the first axis and the direction of the second axis can be shortened. Another advantage is that an electric motor having a large diameter and a low rotation speed can be set as the first electric motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a split-type hybrid electric vehicle according to Embodiment 1 of the present disclosure;

FIG. 2 is a schematic configuration diagram of a series-type hybrid electric vehicle according to Embodiment 2 of the present disclosure; and

FIG. 3 is a schematic configuration diagram of a series-type hybrid electric vehicle according to Embodiment 3 of the present disclosure.

### DETAILED DESCRIPTION OF EMBODIMENTS

Each embodiment of the present disclosure will be described in detail below with reference to the drawing. Unless otherwise mentioned in each embodiment, the drawing is simplified or deformed as appropriate and the dimensional ratios, the shapes, etc. of parts are not necessarily accurately depicted.

### Embodiment 1

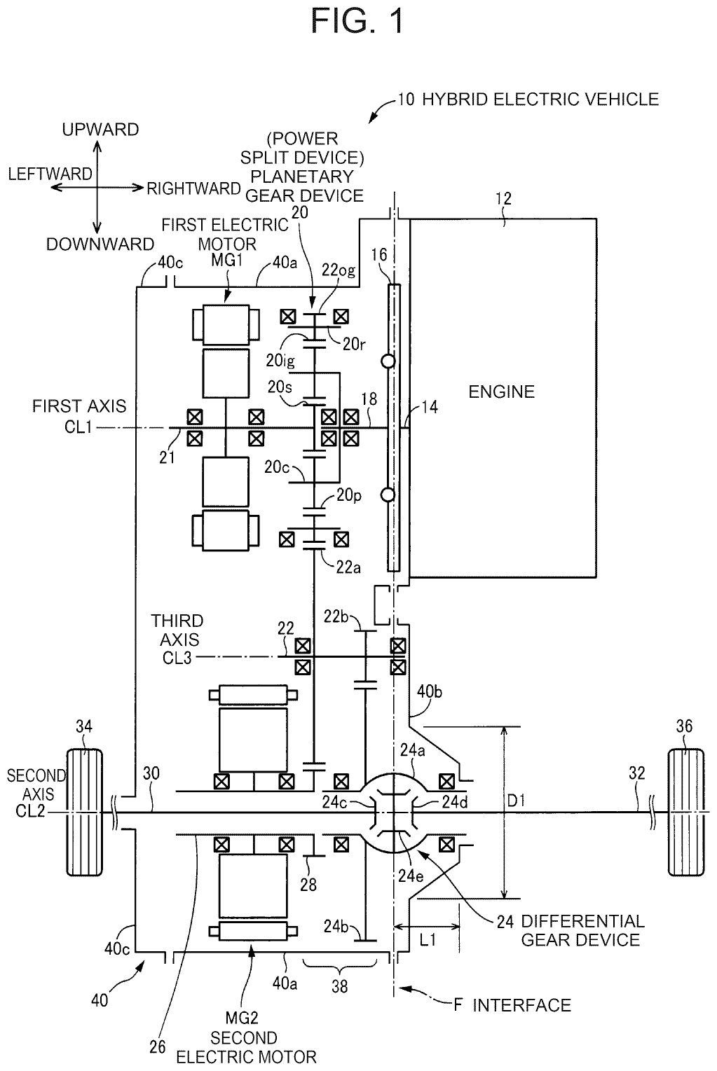

FIG. 1 is a diagram for describing the schematic configuration of a split-type hybrid electric vehicle 10 (hereinafter referred to simply as “vehicle 10”) according to Embodiment 1 of the present disclosure. In FIG. 1, upward and downward in the direction of a vertical line of the vehicle 10 and leftward and rightward in a vehicle width direction are each indicated by an arrow. FIG. 1 is a diagram of the vehicle 10 as seen from a rear side toward a front side, and the devices shown inside a transaxle case 40 are shown so as to reflect relative positional relationships thereof in an up-down direction and a right-left direction. FIG. 1 is a development diagram passing through a first axis CL1, a third axis CL3, and a second axis CL2.

In the vehicle 10, an engine 12 that is a commonly known internal combustion engine, a crankshaft 14, a damper 16 that absorb torque fluctuations, an input shaft 18, a planetary gear device 20, and a first electric motor MG1 are provided so as to be rotatable around the first axis CL1; a counter shaft 22 is provided so as to be rotatable around the third axis CL3 that is parallel to the first axis CL1; and a second electric motor MG2, a differential gear device 24, a pair of axles 30, 32, and a pair of drive wheels 34, 36 are provided so as to be rotatable around the second axis CL2 that is parallel to the first axis CL1.

The first electric motor MG1 and the second electric motor MG2 are so-called motor-generators having a function as an electric motor and a function as a power generator.

The planetary gear device 20 includes a sun gear 20s that is coupled or connected to a first rotor shaft 21 of the first electric motor MG1, a carrier 20c that supports a planetary gear 20p meshing with the sun gear 20s so as to be able to rotate as well as revolve and is coupled or connected to the engine 12, and a ring gear 20r having inner circumferential teeth 20ig that mesh with the planetary gear 20p and outer circumferential teeth 20og that mesh with a counter driven gear 22a. In this embodiment, an input torque from the engine 12 is distributed to the first electric motor MG1 and the ring gear 20r, and thus the planetary gear device 20 functions as a power split device.

On the counter shaft 22, the counter driven gear 22a having a relatively large diameter and a counter drive gear 22b having a relatively small diameter are provided. The counter driven gear 22a meshes with the outer circumferential teeth 20og of the ring gear 20r and a second output gear 28 that has a smaller diameter than the counter driven gear 22a and is provided on a second rotor shaft 26 of the second electric motor MG2. The counter drive gear 22b meshes with a differential input gear 24b that has a larger diameter than the counter drive gear 22b and is fixed on a differential case 24a of the differential gear device 24. The gear pair of the counter driven gear 22a and the second output gear 28, the gear pair of the counter drive gear 22b and the differential input gear 24b, and the counter shaft 22 constitute a speed reduction mechanism 38 that transmits rotation of the second rotor shaft 26 of the second electric motor MG2 to the differential case 24a after reducing the speed of the rotation. In this embodiment, the speed reduction mechanism 38 transmits rotation of the ring gear 20r to the differential case 24a after reducing the speed of the rotation.

The differential gear device 24 includes the differential case 24a that is supported so as to be rotatable around the second axis CL2, a pair of side gears 24c, 24d that is rotatably supported inside the differential case 24a in a state of being coupled to shaft ends of the axles 30, 32, and a pinion 24e that is provided inside the differential case 24a, around an axis orthogonal to the second axis CL2, and meshes with the side gears 24c, 24d between these side gears 24c, 24d.

One axle 30 of the axles 30, 32 penetrates through the pipe-shaped second rotor shaft 26 of the second electric motor MG2 and couples one drive wheel 34 of the drive wheels 34, 36 and one side gear 24c of the side gears 24c, 24d to each other, and the other axle 32 couples the other drive wheel 36 and the other side gear 24d to each other.

The damper 16, the planetary gear device 20, the first electric motor MG1, the counter shaft 22, the second electric motor MG2, and the differential gear device 24 are housed inside the liquid-tight transaxle case 40 composed of a case main body 40a, a first case cover 40b on the engine side, and a second case cover 40c on the opposite side from the engine 12. The engine 12 is combined with and fixed on the case main body 40a through an interface F. In FIG. 1, the devices shown inside the transaxle case 40 are shown so as to reflect the relative positional relationships thereof in the up-down direction and the right-left direction.

The hybrid electric vehicle 10 configured as described above constitutes a so-called split-type HEV. In a power transmission mechanism of the hybrid electric vehicle 10, motive power output from the engine 12 is split toward the first electric motor MG1 and the ring gear 20r by the planetary gear device 20 via the damper 16 and the input shaft 18. The first electric motor MG1 outputs a reaction force torque by regeneration (power generation) in response to a torque of the engine 12 split toward the first electric motor MG1 by the planetary gear device 20, and controls a torque directly transmitted to the counter drive gear 22b. The first electric motor MG1 and the planetary gear device 20 function as an electrical continuously variable transmission in which a differential state of the planetary gear device 20 is controlled as an operation state of the first electric motor MG1 is controlled. The electricity generated by the first electric motor MG1 is used to charge a battery (not shown) or drive the second electric motor MG2.

In the direction of the second axis CL2 (the same direction as the direction of the first axis CL1), the first electric motor MG1 and the second electric motor MG2 are disposed at overlapping positions. That is, as seen in a radial direction centered on the second axis CL2, the second electric motor MG2 is disposed at a position overlapping the first electric motor MG1. In this embodiment, the second electric motor MG2 is disposed directly under the first electric motor MG1. In the direction of the second axis CL2, the second electric motor MG2 and the differential gear device 24 are disposed in this order from the side of the first electric motor MG1 toward the side of the engine 12. In the direction of the second axis CL2, the engine 12 and part of the differential gear device 24 are disposed at positions overlapping each other. That is, as seen in the radial direction centered on the second axis CL2, part of the differential gear device 24 and part of the counter shaft 22 are disposed at positions overlapping a lower side of the engine 12. In this embodiment, part of the differential gear device 24 is disposed directly under the engine 12. That is, in the direction of the second axis CL2, directly under the engine 12, part of the differential gear device 24 and part of the counter shaft 22 are disposed so as to protrude toward the side of the engine 12 beyond the interface F of the engine 12.

That part of the differential gear device 24 and part of the counter shaft 22 are disposed so as to protrude toward the side of the engine 12 beyond the interface F of the engine 12 means that the other part of the differential gear device 24 and the other part of the counter shaft 22 are housed inside the case main body 40a. Thus, a protrusion length L1 of the first case cover 40b on the engine side and a radial dimension D1 of the first case cover 40b except for an outer circumferential flange for assembly are significantly reduced.

According to this embodiment, (a) inside the transaxle case 40 combined with the engine 12, the planetary gear device 20, the first electric motor MG1, and the crankshaft 14 of the engine 12 are disposed so as to be rotatable around the first axis CL1; the second electric motor MG2 and the differential gear device 24 are disposed so as to be rotatable around the second axis CL2 that is parallel to the first axis CL1; the second electric motor MG2, the speed reduction mechanism 38, and the differential gear device 24 are disposed in this order from the side of the first electric motor MG1 toward the side of the engine 12; (b) the speed reduction mechanism 38 includes the counter shaft 22 that is provided so as to be rotatable around the third axis CL3 that is parallel to the first axis CL1 and the second axis CL2, the counter driven gear 22a which is provided on the counter shaft 22 and into which a torque directly transmitted from the engine 12 and a torque from the second electric motor MG2 are input, and the counter drive gear 22b that has a smaller diameter than the counter driven gear 22a and is provided on the counter shaft 22 to drive the differential gear device 24; and (c) at least either part of the differential gear device 24 or part of the counter shaft 22 is disposed so as to protrude toward the side of the engine 12 beyond the interface F between the engine 12 and the transaxle case 40. Thus, the speed reduction mechanism 38 includes the counter shaft 22 on which each of the counter driven gear 22a into which motive power is input from the second electric motor MG2 and the counter drive gear 22b that has a smaller diameter than the counter driven gear 22a and drives the differential gear device 24 is provided. This eliminates the need for a ring gear on an outer side of a stepped pinion, and thus prevents an increase in the outside diameter of the first case cover 40b that protrudes from the case main body 40a of the transaxle case 40 toward the engine side so as to house the differential mechanism. Since at least either part of the differential gear device 24 or part of the counter shaft 22 is disposed so as to protrude toward the side of the engine 12 beyond the interface F between the engine 12 and the transaxle case 40, the dimension of the transaxle case 40 in the direction of the second axis CL2, i.e., the protrusion length L1 of the first case cover 40b can be shortened.

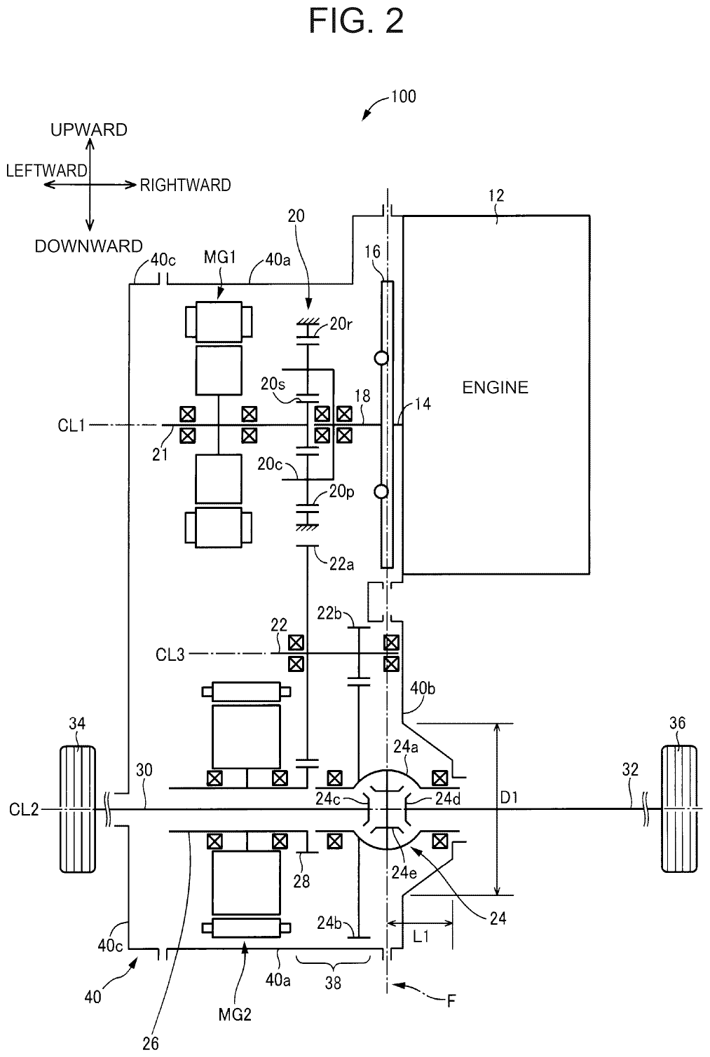

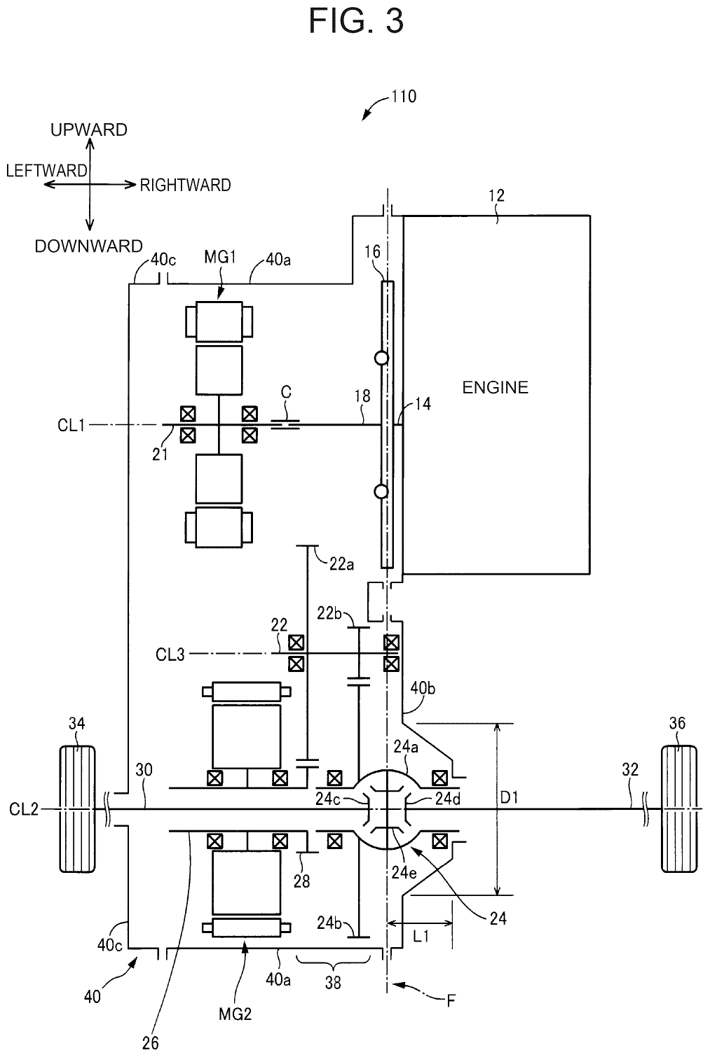

Next, other embodiments of the present disclosure will be described using FIG. 2 and FIG. 3. In the following embodiments, the same parts as in the foregoing embodiment will be denoted by the same reference signs and description thereof will be omitted.

### Embodiment 2

FIG. 2 is a schematic configuration diagram of a hybrid electric vehicle 100 (hereinafter referred to simply as “vehicle 100”) according to Embodiment 2 of the present disclosure. In FIG. 2, as in FIG. 1, upward and downward in the direction of the vertical line of the vehicle 100 and leftward and rightward in the vehicle width direction are each indicated by an arrow, and the vehicle 100 as seen from the rear side toward the front side is shown.

The vehicle 100 has substantially the same configuration as the vehicle 10 according to the foregoing Embodiment 1, but is different in that the vehicle 100 is configured such that motive power of the engine 12 is not transmitted to the pair of drive wheels 34, 36. Therefore, differences from Embodiment 1 will be mainly described.

The vehicle 100 is different in that, unlike the planetary gear device 20 in the vehicle 10 of Embodiment 1, the ring gear 20r does not include the outer circumferential teeth 20og and the ring gear 20r is fixed on a non-rotary member, for example, the case main body 40a. The planetary gear device 20 in which the ring gear 20r is fixed transmits rotation from the engine 12 to the first rotor shaft 21 of the first electric motor MG1 coupled to the sun gear 20s after increasing the speed of the rotation. That is, the planetary gear device 20 of this embodiment functions as a speed-increasing transmission.

The hybrid electric vehicle 100 configured as described above constitutes a so-called series-type HEV. In a power transmission mechanism of the hybrid electric vehicle 100, motive power output from the engine 12 is transmitted exclusively to the first electric motor MG1 after the speed of the rotation is changed so as to increase by the planetary gear device 20 via the damper 16 and the input shaft 18. The first electric motor MG1 is driven to rotate by the rotation of which the speed has been changed so as to increase by the planetary gear device 20, and outputs generated electricity, which is stored in an electricity storage device (not shown) or supplied to the second electric motor MG2, so that a driving force for the vehicle is generated from the second electric motor MG2.

Also in this embodiment, in the direction of the second axis CL2, the first electric motor MG1 and the second electric motor MG2 are disposed at overlapping positions. That is, as seen in the radial direction centered on the second axis CL2, the second electric motor MG2 is disposed at a position overlapping the first electric motor MG1. In this embodiment, the second electric motor MG2 is disposed directly under the first electric motor MG1. In the direction of the second axis CL2, the second electric motor MG2 and the differential gear device 24 are disposed in this order from the side of the first electric motor MG1 toward the side of the engine 12. In the direction of the second axis CL2, the engine 12 and part of the differential gear device 24 are disposed at positions overlapping each other. That is, as seen in the radial direction centered on the second axis CL2, part of the differential gear device 24 and part of the counter shaft 22 are disposed at positions overlapping the lower side of the engine 12. In this embodiment, part of the differential gear device 24 is disposed directly under the engine 12. That is, in the direction of the second axis CL2, directly under the engine 12, part of the differential gear device 24 and part of the counter shaft 22 are disposed so as to protrude toward the side of the engine 12 beyond the interface F of the engine 12.

That part of the differential gear device 24 and part of the counter shaft 22 are disposed so as to protrude toward the side of the engine 12 beyond the interface F of the engine 12 means that the other part of the differential gear device 24 and the other part of the counter shaft 22 are housed inside the case main body 40a. Thus, also in this embodiment, the protrusion length L1 and the radial dimension D1 of the first case cover 40b on the engine side are significantly reduced.

According to this embodiment, as in the foregoing Embodiment 1, (a) the engine 12 and the first electric motor MG1 are each disposed so as to be rotatable around the first axis CL1; (b) the second electric motor MG2 and the differential gear device 24 are each disposed so as to be rotatable around the second axis CL2 that is parallel to the first axis CL1; (c) in the direction of the second axis CL2, the second electric motor MG2, the counter shaft 22, and the differential gear device 24 are disposed in this order from the side of the first electric motor MG1 toward the side of the engine 12; and (d) at least either part of the differential gear device 24 or part of the counter shaft 22 is disposed so as to protrude toward the side of the engine 12 beyond the interface F between the engine 12 and the transaxle case 40. Thus, the same effects as in Embodiment 1 that are based on these configurations are produced.

According to this embodiment, (a) inside the transaxle case 40 combined with the engine 12, the planetary gear device 20, the first electric motor MG1, and the crankshaft 14 of the engine 12 are disposed so as to be rotatable around the first axis CL1; the second electric motor MG2 and the differential gear device 24 are disposed so as to be rotatable around the second axis CL2 that is parallel to the first axis CL1; the second electric motor MG2, the speed reduction mechanism 38, and the differential gear device 24 are disposed in this order from the side of the first electric motor MG1 toward the side of the engine 12; (b) the speed reduction mechanism 38 includes the counter shaft 22 that is provided so as to be rotatable around the third axis CL3 that is parallel to the first axis CL1 and the second axis CL2, the counter driven gear 22a which is provided on the counter shaft 22 and into which motive power is input from the second electric motor MG2, and the counter drive gear 22b that has a smaller diameter than the counter driven gear 22a and is provided on the counter shaft 22 to drive the differential gear device 24; and (c) at least either part of the differential gear device 24 or part of the counter shaft 22 is disposed so as to protrude toward the side of the engine 12 beyond the interface F between the engine 12 and the transaxle case 40. Thus, the speed reduction mechanism 38 includes the counter shaft 22, the counter driven gear 22a which is provided on the counter shaft 22 and into which motive power is input from the second electric motor MG2, and the counter drive gear 22b that has a smaller diameter than the counter driven gear 22a and is provided on the counter shaft 22 to drive the differential gear device 24. This eliminates the need for a ring gear on the outer side of a stepped pinion, and thus prevents an increase in the outside diameter of the first case cover 40b on the engine side that protrudes from the case main body 40a of the transaxle case 40 so as to house the differential mechanism. Since at least either part of the differential gear device 24 or part of the counter shaft 22 is disposed so as to protrude toward the side of the engine 12 beyond the interface F between the engine 12 and the transaxle case 40, the dimension of the transaxle case 40 in the direction of the second axis CL2, i.e., the protrusion length L1 of the first case cover 40b can be shortened.

According to this embodiment, the first electric motor MG1 is coupled to the engine 12 through the planetary gear device 20 that functions as a speed-increasing transmission, so that the first electric motor MG1 is likely to be rotated at a high rotation speed and power generation efficiency in the first electric motor MG1 can be improved. Preferably, when the first electric motor MG1 is configured to have a small diameter and be able to efficiently generate electricity at a high rotation speed, for example, compared with when this is not the case, an increase in the axis-to-axis distance between the first axis CL1 and the second axis CL2 is likely to be avoided while the power generation efficiency in the first electric motor MG1 is improved.

### Embodiment 3

FIG. 3 is a schematic configuration diagram of a hybrid electric vehicle 110 (hereinafter referred to simply as “vehicle 110”) according to Embodiment 3 of the present disclosure. In FIG. 3, upward and downward in the direction of the vertical line of the vehicle 110 and leftward and rightward in the vehicle width direction are each indicated by an arrow. FIG. 3 is a diagram of the vehicle 110 as seen from the rear side toward the front side. In FIG. 3, the devices shown inside the transaxle case 40 are shown so as to reflect relative positional relationships thereof in the up-down direction and the right-left direction.

The vehicle 110 has substantially the same configuration as the vehicle 100 according to the foregoing Embodiment 2, but is different in that it does not include the planetary gear device 20 functioning as a speed-increasing transmission. Therefore, differences from Embodiment 2 will be mainly described, and substantially the same parts will be denoted by the same reference signs and description thereof will be omitted as appropriate.

The vehicle 110 does not include the speed-increasing planetary gear device 20 of the vehicle 100 according to Embodiment 2, and the input shaft 18 is, for example, spline-fitted with the first rotor shaft 21 at a joint C so as to be unable to rotate relative to the first rotor shaft 21. Thus, in the vehicle 110, the engine 12 and the first electric motor MG1 are directly coupled to each other so as to have the same rotation speed. The first electric motor MG1 is driven to rotate by motive power of the engine 12. The hybrid electric vehicle 110 configured as described above constitutes a so-called series-type HEV.

According to this embodiment, as in the foregoing Embodiment 1 and Embodiment 2, (a) the engine 12 and the first electric motor MG1 are each disposed so as to be rotatable around the first axis CL1; (b) the second electric motor MG2 and the differential gear device 24 are each disposed so as to be rotatable around the second axis CL2 that is parallel to the first axis CL1; (c) in the direction of the second axis CL2, the second electric motor MG2, the counter shaft 22, and the differential gear device 24 are disposed in this order from the side of the first electric motor MG1 toward the side of the engine 12; and (d) at least either part of the differential gear device 24 or part of the counter shaft 22 is disposed so as to protrude toward the side of the engine 12 beyond the interface F between the engine 12 and the transaxle case 40. Thus, the same effects as in Embodiment 1 and Embodiment 2 that are based on these configurations are produced.

According to this embodiment, the input shaft 18 and the first rotor shaft 21 are directly coupled to each other such that the engine 12 and the first electric motor MG1 have the same rotation speed. Thus, compared with when the engine 12 and the first electric motor MG1 are coupled to each other not directly but, for example, via the speed-increasing planetary gear device 20, the sizes, in the direction of the first axis CL1, of the engine 12 and the first electric motor MG1 that are disposed so as to be rotatable around the first axis CL1 can be reduced. Preferably, when the first electric motor MG1 is configured to have a large diameter and be able to efficiently generate electricity at a low rotation speed, for example, compared with when this is not the case, the sizes of the engine 12 and the first electric motor MG1 in the direction of the first axis CL1 can be reduced.

What has been described above is embodiments of the present disclosure, and the present disclosure can be implemented in forms in which various changes and improvements have been made based on the knowledge of those skilled in the art within such a range that no departure is made from the gist of the present disclosure.

The foregoing Embodiments 1, 2, 3 adopt the form in which the damper 16 is provided between the engine 12 and the first electric motor MG1, but the present disclosure is not limited thereto. For example, the present disclosure is also applicable to a form in which the damper 16 is not provided between the engine 12 and the first electric motor MG1.

The foregoing Embodiments 1, 2, 3 adopt the form in which the second axis CL2 passes directly under the engine 12, but the present disclosure is not limited to this form. For example, the present disclosure is also applicable to a form in which the second axis CL2 is offset from the first axis CL1 toward either the front side or the rear side in the front-rear direction of the vehicles 10, 100, 110, and the second axis CL2 does not pass directly under the engine 12. Also in this case, an increase in the outside diameter of the first case cover 40b around the second axis CL2 is avoided. Thus, the engine 12 that is disposed so as to be rotatable around the first axis CL1 and devices of the power train that are disposed so as to be rotatable around the second axis CL2 can be disposed while an increase in the axis-to-axis distance between the first axis CL1 and the second axis CL2 is avoided. That is, an increase in the overall size of the engine 12 and the devices of the power train is avoided.

In the foregoing Embodiments 1, 2, 3, part of the counter shaft 22 and part of the differential gear device 24 both protrude from the interface F, but it is also acceptable that only one of them protrudes. In short, at least either part of the counter shaft 22 or part of the differential gear device 24 should protrude.

What is claimed is:

1. A hybrid electric vehicle in which, inside a transaxle case combined with an engine, a first electric motor and a crankshaft of the engine are disposed so as to be rotatable around a first axis, a second electric motor and a differential gear device are disposed so as to be rotatable around a second axis that is parallel to the first axis, and the second electric motor, a speed reduction mechanism, and the differential gear device are disposed in this order from a first electric motor side toward an engine side, wherein:
the speed reduction mechanism includes a counter shaft that is provided so as to be rotatable around a third axis that is parallel to the first axis and the second axis, a counter driven gear which is provided on the counter shaft and into which motive power is input from the second electric motor, and a counter drive gear that has a smaller diameter than the counter driven gear and is provided on the counter shaft to drive the differential gear device; and
at least either part of the differential gear device or part of the counter shaft is disposed so as to protrude toward the engine side beyond an interface between the engine and the transaxle case.

2. The hybrid electric vehicle according to claim 1, wherein:
between the engine and the first electric motor, a planetary gear device is disposed, the planetary gear device having a sun gear that is connected to a rotor shaft of the first electric motor, a carrier that is connected to the crankshaft of the engine, a planetary gear that is rotatably supported by the carrier, and a ring gear with which the planetary gear supported by the carrier meshes; and
outer circumferential teeth of the ring gear mesh with the counter driven gear.

3. The hybrid electric vehicle according to claim 1, wherein:
between the engine and the first electric motor, a planetary gear device is disposed, the planetary gear device having a sun gear that is connected to a rotor shaft of the first electric motor, a carrier that is connected to the crankshaft of the engine, a planetary gear that is rotatably supported by the carrier, and a ring gear with which the planetary gear supported by the carrier meshes; and
the ring gear is fixed on the transaxle case.

4. The hybrid electric vehicle according to claim 1, wherein the engine and the second electric motor are directly coupled to each other.
